(19) United States
(12) Patent Application Publication
(10) Pub. No.: US 2014/0116029 A1
(43) Pub. Date: May 1, 2014

(54) EXHAUST TEMPERATURE CONTROL

(71) Applicants: Darryl William Hylands, Gotham, Nottingham (GB); Trevor Lee Fletcher, Nr Loughbirough (GB)

(72) Inventors: Darryl William Hylands, Gotham, Nottingham (GB); Trevor Lee Fletcher, Nr Loughbirough (GB)

(73) Assignee: T. Baden Hardstaff Ltd, Kingston-on-Soar, Nottingham (GB)

(21) Appl. No.: 14/114,302

(22) PCT Filed: May 4, 2012
(86) PCT No.: PCT/GB2012/050988

§ 371 Date: Jan. 2, 2014

(30) Foreign Application Priority Data
May 4, 2011 (GB) 1107404.4

(51) Int. Cl. F01N 9/00; F02D 41/00; F01N 11/00; F01N 3/20

(52) U.S. Cl. CPC F01N 9/00; F01N 3/2066; F02D 41/0027; F01N 11/002
USPC 60/274; 60/276; 60/301; 701/103

(57) ABSTRACT

An exhaust system (10) for a dual fuel engine, which engine is adapted to operate in a first mode in which the engine is fuelled entirely by a liquid fuel, and a second mode in which the engine is fuelled predominately by a gaseous fuel, the system comprising a first oxidation catalyst (22), a first temperature sensor (30) adapted to measure a core temperature of the first oxidation catalyst, and a controller (32) for controlling whether the engine operates in the first mode or the second mode, wherein the first temperature sensor is operatively connectable to the controller such that the controller prevents the engine from running in the second mode if the core temperature of the first oxidation catalyst is below a predetermined temperature.

This invention relates to an exhaust system for use with an engine system, and in particular, relates to an exhaust system for a multi-mode engine system such as a dual fuel engine system. The invention further relates to a catalyst assembly forming part of the exhaust system, and to an engine system incorporating the exhaust system.

A dual fuel engine is adapted to operate in two modes. Typically a first mode is a diesel mode in which the engine is fuelled entirely by diesel fuel, and a second mode is a gaseous fuel mode in which the engine is fuelled predominately by a gaseous fuel such as natural gas (methane) or propane which is ignited by a relatively small quantity of diesel.

This invention relates particularly, but not exclusively, to an exhaust system for a dual fuel engine system comprising an engine that runs on diesel and another fuel such as natural gas. It is to be understood, however, that the invention relates to an exhaust system for any multi-mode engine system running on any combination of fuels.

The operation of an engine such as an internal combustion engine on a mixture of a liquid fuel such as diesel, and a gaseous fuel such as methane maintains the fuel economy and engine efficiency of the engine, whilst at the same time reduces levels of undesirable exhaust emissions. As people generally become more aware of the disastrous effect on the environment and weather of the consumption of hydrocarbon fuels, there is a greater need to reduce carbon emissions from vehicles such as heavy goods vehicles. One way in which these emissions can be reduced is by powering such vehicles with dual fuel engines which, for at least some of the time, are fuelled predominately by methane, for example.

Whilst it is known to manufacture engine systems that are able to operate on both diesel and methane, there are many existing conventional diesel engines which cannot be simply replaced for economic reasons.

There is therefore a need to be able to convert existing internal combustion engines designed to run on, for example, diesel, into dual fuel engines which may run on diesel or methane, or a combination of two or more fuels.

Existing diesel engines, particularly of the unit injector or common rail type, are controlled by an electronic ECU. This ECU, known as a diesel ECU, controls the injection of diesel into the engine. The ECU comprises an engine map which is essentially a three-dimensional data array installed by the Original Equipment Manufacturer (OEM) which allows the diesel ECU to determine the amount of diesel to be injected into the engine, and the timing of the injection, depending on various parameters. The amount of diesel injected into the engine provides appropriate energy to the engine, taking into account prevailing conditions.

A known engine system comprises a plurality of sensors which measure a plurality of variables such as:

Accelerator Pedal position;

Intake Manifold pressure;

Engine temperature;

Vehicle speed;

Engine speed;

Engine position;

Oil pressure; and

Fuel pressure.

The sensors supply the ECU with information relating to these parameters. The engine mapping enables the ECU to determine the required level of fuel injection dependent on these parameters, and also in conjunction with other components with ECUs on the vehicle, such as electronic gearbox control, electronic braking systems, and traction control. Typically component ECUs will share information through a controller area network (CAN), and can have an effect on the final required level of fuel injection.

The diesel ECU instructs each of the injectors of the engine to inject a predetermined amount of diesel into the engine at a predetermined time dependent on the parameters measured, by sending a pulse signal to the injector. The injector is generally controlled by the width of the pulse and therefore pulse width modulation may be used to vary the amount of fuel injected into the engine. The diesel ECU also controls the timing of injection of diesel into the engine by each of the injectors.

If an engine is to be adapted to run in a second mode in which a mixture of diesel and methane is to be used to fuel the engine, the ECU must be adapted to instruct each of the diesel injectors to inject less diesel into the engine when the engine is running in the second mode.

In other words, when the engine is running in the second mode, less diesel is required to be injected into the engine per unit time than when the engine is running on diesel only. The reduced amount of diesel required in a second mode is augmented with methane in order that the engine system has sufficient fuel to operate in a second mode. In other words, some of the diesel is substituted with gas.

In most countries of the world, regulations exist to limit the level of exhaust emissions produced by, for example, road vehicles. These regulations are becoming ever more demanding in order to prevent the environment becoming more polluted.

One of the main pollutants contained within exhaust gases of an engine fuelled by diesel is nitrogen oxide (NOₓ. As it is known in the art, NOₓ is the generic term for mono-nitrogen (NO and NO₂).

In order to meet such emission regulations it is known to use a catalyst known as a selective catalytic reduction (SCR) catalyst in the exhaust system of a diesel engine in order to enable the levels of NOₓ in exhaust gases to be reduced. Such a catalyst forms part of a selective catalytic reduction (SCR) system. Known SCR systems comprise an SCR catalyst used in combination with urea.

A selective catalytic reduction (SCR) system is a means of removing nitrogen oxides from exhaust gases through a chemical reaction between the exhaust gases, a reductant, and a catalyst.

A gaseous or liquid reductant, most commonly ammonia or urea, is added to a stream of exhaust gas. The mixture is then absorbed onto a catalyst. The reductant reacts with NOₓ in the exhaust gases to form harmless water vapour (H₂O) and nitrogen gas (N₂).

It is known to use a vanadium based catalyst, or a catalyst with zeolites as an SCR catalyst in an SCR system.

Vanadium catalysts tend to be deactivated at temperatures above 600° C., whereas catalysts incorporating zeolites are more durable at higher temperatures and are therefore usually able to withstand extended operation at temperatures above 650° C., in addition to brief exposure to temperatures between 750 to 800° C.

It is additionally known to use iron and copper exchange zeolite catalysts together with urea as a reductant to form an efficient SCR system.

The SCR catalyst could of course be formed from any suitable material.

When NOₓ reacts with the reactant (urea or ammonia) the following chemical reactions occur:

6NO+4NH₃→5N₂+6H₂O

4NO+4NH₃+O₂→4N₂+6H₂O

6NO₂+8NH₃→7N₂+12H₂O

2NO₂+4NH₃+O₂→3N₂+6H₂O

NO+NO₂+2NH₃→2N₂+3H₂O

When urea is used as the reactant, water solutions of urea are injected into an exhaust gas stream and evaporated. This is then followed by decomposition of urea to produce ammonia and carbon dioxide. It is preferable to use urea rather than ammonia due to the toxicity and resultant handling problems associated with using ammonia.

When an internal combustion engine runs in the second mode and is fuelled predominately by methane, a main pollutant contained in the exhaust gases is uncombusted methane. It is known to use a methane oxidising catalyst to facilitate a reduction of methane in such exhaust gases. A methane oxidising catalyst enables uncombusted methane to react with oxygen to produce carbon dioxide and water.

Once exhaust gases have passed through the methane catalyst, the temperature of the exhaust gases will vary depending on the mode in which the engine is running. When the engine is running in the second mode, predominately on methane, excess methane will be oxidised on passing through the methane catalyst. This reaction generates heat thus increasing the exhaust gas temperature to 450-650° C. On the other hand, when the engine is running in the first mode in which diesel is the predominate fuel, there will be no excess methane to be oxidised and therefore the temperature of the exhaust gases will remain substantially at 250-450° C.

It is known that a methane oxidation catalyst typically operates effectively only at or above a minimum “light-off” temperature. This temperature is typically around 350 to 475° C. depending on coating.

In order to insure that a methane oxidation catalyst achieves the optimum conversion efficiency, it is important to ensure that the oxidation catalyst has reached its light off temperature before the engine allowed to run in the second mode.

According to a first aspect of the present invention there is provided an exhaust system for a dual fuel engine, which engine is adapted to operate in a first mode in which the engine is fuelled entirely by a liquid fuel, and a second mode in which the engine is fuelled predominately by a gaseous fuel, the system comprising a first oxidation catalyst, a first temperature sensor adapted to measure a core temperature of the first oxidation catalyst, and a controller for controlling whether the engine operates in the first mode or the second mode, wherein the first temperature sensor is operatively connectable to the controller such that the controller prevents the engine from running in the second mode if the core temperature of the first oxidation catalyst is below a first predetermined temperature.

The first predetermined temperature may be the ‘light-off’ temperature for the catalyst.

By means of the first temperature sensor it is possible to monitor the core temperature of the first oxidation catalyst.

The temperature sensor is operatively connectable to the controller which controls whether or not the engine switches into the dual fuel, or second mode of operation.

According to a second aspect of the present invention there is provided an engine system comprising a multimode engine system comprising an engine adapted to operate in a plurality of different modes including a first mode in which the engine is fuelled substantially entirely by a first fuel, and a second mode in which the engine is fuelled substantially entirely by a second fuel, or by a mixture of the first and second fuels, the engine comprising: a first engine control unit (ECU) for controlling the flow of the first fuel into the engine when the engine is operating in a first mode; a plurality of first sensors operatively connected to the first ECU, each of which first sensors is adapted to sense a first variable, and to emit a first input signal dependent on the value of the sensed first variable; and a second ECU operatively connected to the first ECU; wherein the first ECU comprises: a signal receiver for receiving the first input signals and an output for emitting a first output signal dependent on the first input signals, which first output signal determines the amount of first fuel supplied to the engine, the second ECU being adapted to modify the first output signal when the engine is running in the second mode to produce a first modified signal and a second calculated signal; the first modified signal determining the amount of first fuel supplied to the engine when the engine is operating in the second mode, and a second calculated signal determining the amount of second fuel supplied to the engine when the engine is operating in a second mode; wherein the engine system comprises an exhaust system comprising a first oxidation catalyst, a first temperature sensor adapted to measure a core temperature of the first oxidation catalyst, the first temperature sensor being operatively connectable to the first ECU such that the first ECU prevents the engine from running in the second mode if the core temperature of the first oxidation catalyst is below a first predetermined temperature.

The engine system according to the second aspect of the present invention may comprise a dual fuel engine system, and may be adapted to run on diesel in the first mode, and substantially on methane, or a mixture of methane and diesel in the second mode.

In such an engine system, the first temperature sensor may be regarded as one of the plurality of first sensors operatively connected to the first ECU. The first temperature sensor therefore emits a first input signal which is dependent on the core temperature of the first oxidation catalyst.

According to a third aspect of the present invention there is provided a catalyst assembly comprising a first oxidation catalyst, and a first temperature sensor adapted to measure a core temperature of the oxidation catalyst and to emit a first input signal dependent on the value of the core temperature of the oxidation catalyst and to determine whether the core temperature of the oxidation catalyst is below a first predetermined temperature.

According to a fourth aspect of the present invention there is provided a method for controlling operation of an engine system according to the second aspect of the invention comprising the steps of measuring a core temperature of the first oxidation catalyst, and preventing the engine from running in the second mode if the core temperature of the first oxidation catalyst is below a first predetermined temperature.

During operation of a dual fuel engine of which the exhaust system forms a part, the first temperature sensor monitors the core temperature of the first oxidation catalyst. The first temperature sensor then sends a signal to the controller which controls operation of the engine to inform the controller of the core temperature of the first oxidation catalyst. The controller will prevent the engine from entering the dual fuel mode if the core temperature of the first oxidation catalyst is below a first predetermined temperature.

Once the first predetermined temperature has been reached, dual fuel operation may commence. However, the controller will receive signals from other sensors, as described above, which monitor other parameters of the engine system. This means that if any of the sensors which are operatively connected to the controller sends a signal to the controller indicating that it is not appropriate to enter the dual fuel mode, then the engine system will remain in the first mode.

If the core temperature of the first oxidation catalyst drops below the first predetermined temperature, the engine will revert back to the first mode of operation where it is fuelled entirely by diesel. The engine will remain operating in the first mode until the core temperature of the first oxidation catalyst has exceeded the first predetermined temperature.

In some embodiments of the invention a second predetermined temperature may be defined which, for example, differ from the first predetermined temperature by about 10 to 15° C. With such a system it is possible to create a level of hysteresis preventing rapid oscillation between the first and second modes.

In other words, in a system in which first and second predetermined temperatures are defined, the engine may revert back to the first mode of operation if the core temperature of the first oxidation catalyst drops below the first predetermined temperature and the engine may remain operating in the first mode until the core temperature of the first oxidation catalyst has exceeded the second predetermined temperature which is higher than the first predetermined temperature.

In other systems, the engine may remain in the second mode of operation even though the core temperature of the first oxidation catalyst has dropped below the first o predetermined temperature, and may revert back to the first mode of operation only when the core temperature of the first oxidation catalyst drops below the second predetermined temperature which is lower than the first predetermined temperature. In such a system, the engine may remain in the first mode of operation until the core temperature of the first oxidation catalyst exceeds the first predetermined temperature.

By means of the present invention therefore the engine is prevented from running in the second mode if the core temperature of the first oxidation catalyst is not sufficiently high. This prevents, or reduces the levels of excess methane in the exhaust stream exhausted from the exhaust system and into the environment.

The invention is applicable to any dual fuel type engine system, but is particularly suitable for use with a dual fuel engine in which the liquid fuel comprises methane. When used with such a dual fuel engine system, the oxidation catalyst comprises a methane oxidation catalyst.

The exhaust system may comprise a second oxidation catalyst which, together with the first oxidation catalyst forms an oxidation assembly.

In such an embodiment of the invention, the first and second oxidation catalysts may be spaced apart from one another and positioned within an oxidation catalyst housing.

In such embodiments the first temperature sensor may be positioned between the first and second oxidation catalysts.

The exhaust system may further comprise a selective catalytic reduction catalyst (SCR) positioned down stream from the oxidation catalyst, or oxidation catalyst assembly. As mentioned hereinabove, an SCR catalyst is adapted to remove nitrogen oxide from exhausts gases. However, since the oxidation of methane by the oxidation catalyst/assembly is an exothermic reaction, the temperature of gases passing through the oxidation catalyst/assembly will be higher than the temperature of the gases before they pass through the catalyst/assembly.

Under certain engine conditions, the temperature of gases exhausted from the oxidation catalyst/assembly may exceed the optimum temperature for the SCR catalyst to achieve its optimum conversion efficiency.

The exhaust system may therefore comprise a second temperature sensor positioned down stream from the methane oxidation catalyst/assembly, and up stream of the SCR catalyst.

The second temperature sensor may, for example be positioned at an entrance to the SCR catalyst, although other positions may also be appropriate.

The second temperature sensor is also operatively connectable to the controller such that the controller will prevent the engine system from connecting to the second mode of operation if the temperature of gases exhausted from the methane oxidation catalyst/assembly exceeds a second predetermined temperature.

When the exhaust system forms part of an engine system according to the second aspect of the present invention, the second temperature sensor may be regarded as one of the plurality of first sensors operatively connected to the first ECU and will emit a first input signal dependent on the value of the sensed temperature.

A method according to the fourth aspect of the present may comprise the further step of measuring the temperature of gases exhausted from the methane oxidation catalyst/assembly and preventing the engine system from running in the second mode of operation if the temperature of such gases exceeds a third predetermined temperature.

Preferably, the exhaust system comprises an input and an output.

The dual fuel engine of the type that the exhaust system according to the invention may form a part of, is described in more detail in International Patent Application No. PCT/GB2008/003188, the contents of which are incorporated by reference.

The invention will now be further described by way of example only with reference to the accompanying drawings in which:

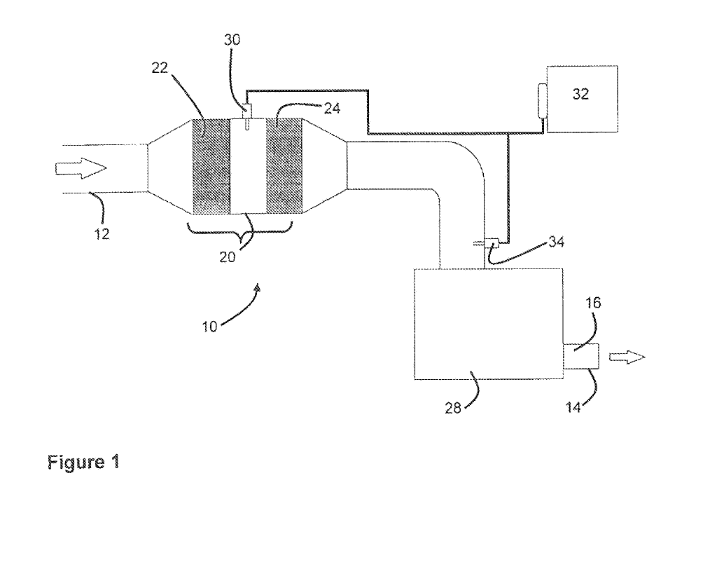

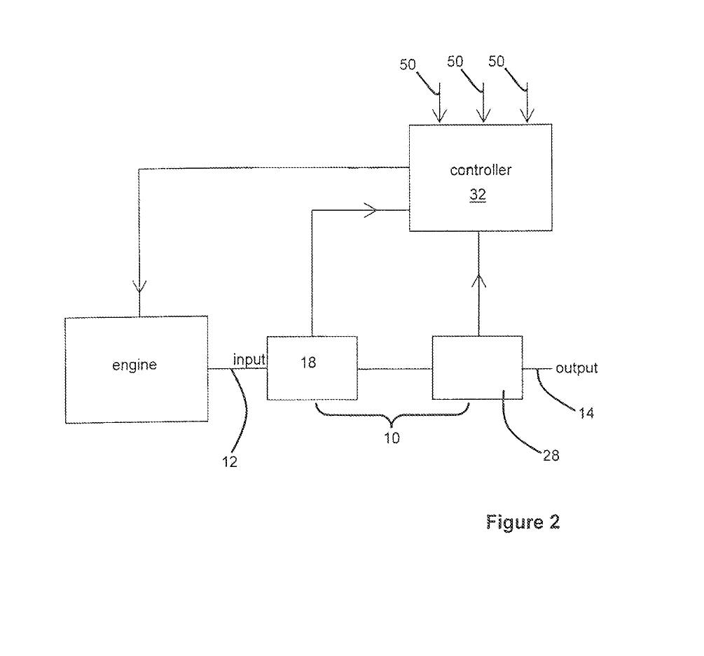

FIG. 1 is a schematic representation of an exhaust system according to an embodiment of the present invention; and o FIG. 2 is a schematic representation of an engine system incorporating an exhaust system and according to the invention.

Referring to the figures, an exhaust system according to an embodiment of the invention is designated generally by the reference numeral 10.

The exhaust system comprises an input 12 and an output 14. In this embodiment the exhaust system output comprises a tail pipe 16. The exhaust system comprises an oxidation catalyst assembly 18 comprising an oxidation assembly 20, which in this example comprises a first methane oxidation catalyst 22, and a second methane oxidation catalyst 24. The oxidation catalyst 22, 24 are spaced apart from one another and are contained within an oxidation housing 26.

The catalyst assembly further comprises an SCR system 28 positioned downstream from the oxidation catalyst assembly 18.

The exhaust system also comprises a first temperature sensor 30, which in this embodiment is positioned between the first and second oxidation catalyst 22, 24. The first temperature sensor 30 is operatively connected to a controller 32 for controlling operation of dual fuel engine system. The engine system, as described hereinabove, is adapted to run in one of two modes, first mode in which the engine uses a first fuel such as diesel, and in a second mode in which the engine runs predominantly on a gaseous fuel such as methane.

The first temperature sensor is adapted to monitor a core temperature of each of the first and second oxidation catalysts 22, 24.

As mentioned above, it is necessary for methane oxidation catalyst to reach a particular temperature (the light off temperature) which is typically around 350° C. in order to achieve optimum conversion efficiency.

The first temperature sensor 30 is therefore adapted to monitor the core temperature of both the first and second oxidation catalysts and to prevent the engine from operating the dual fuel mode if the temperature of the oxidation catalysts has not reached, or falls below, the light off temperature.

In other words, the first temperature sensor which is operatively connected to the controller 32 sends data to the controller based on the core temperature of the first and second oxidation catalysts. If the core temperature does not exceed a predetermined temperature based on the light off temperature of the catalysts, then the controller will prevent the engine from entering the dual fuel mode.

The first temperature sensor 30 will be particularly useful when the engine system is first switched on. At this time it may take a period of time for the first and second oxidation catalysts to reach the required temperature. By means of the first temperature sensor therefore dual fuel operation is hibernated, or delayed, until the core temperature as monitored by the first temperature sensor has reached a predetermined temperature.

During operation of the engine system, if the core temperature of oxidation catalyst drops below a predetermined temperature, then the data transmitted to the controller by the first temperature sensor will cause the controller to switch the engine system back to the first mode in which it runs entirely on diesel. The engine will remain in this mode until the core temperature of the oxidation catalyst has reached the predetermined temperature. However, dual fuel operation will remain in hibernation if other parameters of the engine system are not appropriate for dual fuel mode.

As can be seen from FIG. 2, and as described hereinabove, the controller will receive data represented in FIG. 2 by the reference numeral 50 from other sensors monitoring the different parameters of the engine. All data received by the controller is taken into account when deciding in which mode the engine should run.

In the embodiment of the invention illustrated in FIG. 1, the exhaust system further comprises a second temperature sensor 34 positioned downstream of the catalyst assembly, but upstream of the SCR catalyst 28. The second temperature sensor is also operatively connected to the dual fuel controller and serves to monitor the temperature of exhaust gases that pass through the first catalyst assembly 20.

Because the oxidation of methane in the first catalyst assembly is an exothermic reaction, the temperature of exhaust cases will be higher than the temperature of gases entering the exhaust system. It may be possible therefore that under certain conditions, the temperature of these exhaust gases exceeds the recommended temperature for the

SCR system in order for the SCR system to work at its optimum efficiency. The second temperature sensor is therefore positioned at the entrance to the SCR catalyst. The temperature of the exhaust gases exceeds a predetermined temperature and the data transmitted to the controller by the second temperature sensor will result in a controller switching the engine system from the dual fuel mode to the first mode in which it runs entirely on diesel.

As an alternative to hibernating the dual fuel mode, it is possible to reduce the substitution rate of methane when the maximum exhaust temperature limit is reached in order to reduce the amount of methane entering the exhaust and to thereby reduce the overall exhaust gas temperature.

1. An exhaust system for a dual fuel engine, which engine is adapted to operate in a first mode in which the engine is fuelled entirely by a liquid fuel, and a second mode in which the engine is fuelled predominately by a gaseous fuel, the system comprising a first oxidation catalyst, a first temperature sensor adapted to measure a core temperature of the first oxidation catalyst, and a controller for controlling whether the engine operates in the first mode or the second mode, wherein the first temperature sensor is operatively connectable to the controller such that the controller prevents the engine from running in the second mode if the core temperature of the first oxidation catalyst is below a predetermined temperature.

2. An exhaust system according to claim 1 wherein the gaseous fuel comprises methane, and the first oxidation catalyst is a methane oxidation catalyst.

3. An exhaust system according to claim 1 further comprising a second oxidation catalyst, the first and second oxidation catalysts forming an oxidation assembly.

4. An exhaust system according to claim 1 wherein the system further comprises a Selective Catalytic Reduction (SCR) catalyst positioned down stream of the oxidation catalyst, or oxidation assembly.

5. An exhaust system according to claim 4 further comprising a second temperature sensor operatively connectable to the controller and positioned between the methane oxidising catalyst and the SCR catalyst.

6. An exhaust system according to claim 1 comprising an input and an output.

7. An engine system comprising a multimode engine system comprising an engine adapted to operate in a plurality of different modes including a first mode in which the engine is fuelled substantially entirely by a first fuel, and a second mode in which the engine is fuelled substantially entirely by a second fuel, or by a mixture of the first and second fuels, the engine comprising:
a first engine control unit (ECU) for controlling the flow of the first fuel into the engine when the engine is operating in a first mode;
a plurality of first sensors operatively connected to the first ECU, each of which first sensors is adapted to sense a first variable, and to emit a first input signal dependent on the value of the sensed first variable; and
a second ECU operatively connected to the first ECU; wherein the first ECU comprises: a signal receiver for receiving the first input signals and an output for emitting a first output signal dependent on the first input signals, which first output signal determines the amount of first fuel supplied to the engine, the second ECU being adapted to modify the first output signal when the engine is running in the second mode to produce a first modified signal and a second calculated signal;
the first modified signal determining the amount of first fuel supplied to the engine when the engine is operating in the second mode, and a second calculated signal determining the amount of second fuel supplied to the engine when the engine is operating in a second mode; the engine system comprising an exhaust system according to any one of the preceding claims.

8. A catalyst assembly comprising a first oxidation catalyst, and a first temperature sensor adapted to measure a core temperature of the oxidation catalyst and to emit a first input signal dependent on the value of the core temperature of the oxidation catalyst and to determine whether the core temperature of the oxidation catalyst is below a predetermined temperature.

9. A method for controlling operation of an engine system as claimed in claim 7 comprising the steps of measuring a core temperature of the first oxidation catalyst, and preventing the engine from running in the second mode if the core temperature of the first oxidation catalyst is below a first predetermined temperature.

10. A method according to claim 9 comprising the further step of measuring the temperature of gases exhausted from the methane oxidation catalyst/assembly, and preventing the engine system from running in the second mode of operation if the temperature of such gases exceeds a third predetermined temperature.

11. (canceled)
